(19) United States
(12) Patent Application Publication
(10) Pub. No.: US 2025/0311905 A1
(43) Pub. Date: Oct. 9, 2025

(54) ROBOTIC POOL CLEANING VACUUM WITH DRIVE AXLE AND FREE WHEEL

(71) Applicant: KOKIDO DEVELOPMENT LIMITED, KOWLOON (HK)

(72) Inventors: Max ROUMAGNAC, Martignas Sur Jalle (FR); Jean BRUNEEL, Kowloon (HK)

(21) Appl. No.: 19/092,722

(22) Filed: Mar. 27, 2025

(30) Foreign Application Priority Data
Apr. 3, 2024 (FR) 2403410

(51) Int. Cl. A47L 9/28; A47L 9/14; E04H 4/16

(52) U.S. Cl. CPC A47L 9/2852; A47L 9/1454; A47L 9/2831; E04H 4/1654; A47L 2201/04

(57) ABSTRACT

A robotic pool cleaning vacuum, includes a chassis, a suction duct topping the frame and opening into a filter bag placed above, and an impeller placed inside the duct to suck up debris via a suction port and push it into the filter bag, the chassis including a motor axle drawing the robot, the axle includes two drive wheels driven by a single motor, and an axis connecting the drive wheels transversely to the movement of the robot, the motor being configured to invert its direction of rotation in contact with a wall, the robot further includes a third free wheel for greater stability and maneuverability.

### CROSS-REFERNCE TO RELATED APPLICATIONS

This application is based on and claims priority under 35 U.S.C. § 119 to French Patent Application No. 2403410, filed on Apr. 3, 2024, in the French Intellectual Property Office, the disclosure of which is incorporated by reference herein in its entirety.

### BACKGROUND

### Field

The present disclosure belongs to the field of pool maintenance and cleaning devices, in particular self-propelled robotic vacuum cleaners, and relates more particularly to a robotic vacuum cleaner equipped with an axle with two drive wheels and at least one free wheel for a simple and stabilized drive.

### Brief Description of Related Developments

Over the years, automatic pool cleaning technology has seen a multitude of advances, with autonomous robotic vacuum cleaners becoming predominant in this field. These robots are designed to move autonomously in a pool, removing debris from the bottom of the pool. They can also be adapted to handle different types of debris, such as leaves, sand or other particles, and can be configured to clean different types of pool surfaces, including tiles, concrete or vinyl.

However, the propulsion means of a given robot can have a variable effectiveness depending on the nature of the surfaces.

In general, a robotic pool cleaner operates on a chassis, which is a frame supporting the robot and its components. The chassis often includes wheels or tracks allowing the robot to move in the pool. Some robotic pool cleaners are equipped with two or more wheels, which can be driven by a motor to propel the robot. In some cases, the chassis can include additional wheels or tracks for better stability or handling ability.

The cleaning function of these robots is often carried out by a suction mechanism. This generally involves an impeller or similar device which creates a water flow, sucking up debris from the pool. The debris is generally captured in a filter located upstream of the suction, or more rarely in a downstream bag, for subsequent removal. In some cases, the suction mechanism can comprise several impellers or pumps to increase the suction power. The filter or bag can also be designed with different materials or structures to capture different sizes or types of debris.

In some models, the direction of movement of the robot is controlled by the direction of rotation of the motor driving the wheels. This can be carried out by inverting the direction of rotation of the motor on contact with a wall or other obstacle, which causes the robot to change direction. In other variations, the robot can use sensors to detect the proximity of walls or obstacles and adjust its direction accordingly.

In addition, some robotic pool cleaners include sensors or timers for controlling the direction of rotation of the motor. These can be based on various technologies, such as Hall effect sensors, accelerometers or time delay devices. In some cases, the robot can use other types of sensors, such as optical sensors, ultrasonic sensors, or pressure sensors, to control its movement.

In addition, some robotic pool cleaners are equipped with interchangeable batteries, allowing extended operating times. In some cases, the robot can use other types of energy sources, such as solar energy, or it can include a charging station for automatic charging.

Most self-propelled robots use two traction motors, each associated with a track or pair of wheels (right and left). The independent control of each motor then makes it possible to steer the robot in the desired direction according to preset programming.

Document U.S. Pat. No. 7,849,547 (AquaProducts) describes a self-propelled robotic pool cleaner, comprising a first pair of motor brushes and a second pair of free brushes, mounted coaxially in rotation on parallel axes, at opposite ends of the cleaner, transverse to the direction of movement. The first pair of brushes is mounted on one side and is driven by a drive motor; the second pair of brushes is mounted on the opposite side of the cleaner. A delayed clutch, in rotation, is positioned coaxially between each pair of the first and second brushes, such that inverting the drive motor causes the first pair of driven brushes to temporarily rotate at an angular rotational speed which is greater than that of the second pair of brushes, such that the pivoting of the cleaner, following a predetermined angular change of direction, before the synchronized rotation of the second pair of brushes, is initiated by engaging the clutch. Following each inversion, the cleaner moves in a new direction, along a generally rectilinear path which is angularly shifted with respect to its first path (zigzag trajectory).

However, this solution has limited handling ability on account of the presence of the two rollers, at the front and rear. In addition, the two motor brushes are placed on a lateral side of the robot, parallel to its direction of movement, and can cause a transverse imbalance of the robot or, at least, difficult maneuverability.

### SUMMARY

The present disclosure aims to overcome all or part of the drawbacks of the prior art disclosed hereinabove by providing a simple solution for automatic pool cleaning with improved handling ability, maneuverability and suction capacity.

To this end, the present disclosure relates to a robotic pool cleaning vacuum, including a chassis, a suction duct topping the chassis and opening into a filter bag placed above, and an impeller placed inside said duct to suck up debris via a suction port and push it into the filter bag, the chassis comprising a drive axle towing the robot. This robot is remarkable in that the axle is single and includes two drive wheels driven by a single motor and an axle connecting said drive wheels transversely to the movement of the robot, in that the motor is configured to invert its direction of rotation in contact with a wall, and in that said robot further includes a third free wheel and a non-return system placed between the suction duct and the filter bag to prevent the debris pushed into said bag from falling back into said duct.

This robotic vacuum cleaner, with a chassis having at least three wheels with two drive wheels on the same axle driven by a single motor, offers several technical advantages. Its simplified design reduces manufacturing and maintenance costs. Its improved maneuverability allows it to navigate easily in confined spaces and to get around obstacles accurately. The increased stability ensures regular movement on varied surfaces. Furthermore, the ability of the motor to automatically invert the direction of rotation on contact with a wall allows it to identify and avoid obstacles, ensuring smooth cleaning. To sum up, this configuration maximizes the effectiveness and reliability of the robotic vacuum cleaner, offering a high-performance pool cleaning solution.

According to one aspect, the impeller has a diameter of at least 80 mm, and is referred to as “large-diameter”.

Indeed, the choice between a large-diameter impeller and a small-diameter impeller has direct implications on its effectiveness. A large-diameter impeller offers several technical advantages. Firstly, it moves a greater quantity of water per revolution, which speeds up the circulation in the pool and makes it possible to clean a greater surface area in less time. Furthermore, thanks to its ability to generate a higher suction force, it is more effective at capturing a variety of debris, ranging from leaves to finer debris including sand. This also reduces the risk of clogging, ensuring continuous cleaning without frequent interruptions to unblock the system. Finally, a large-diameter impeller helps reduce the time needed to clean the pool, which saves energy and prolongs the lifetime of the robot battery.

According to one aspect, the non-return system includes at least one hinged rigid flap.

According to one aspect, the non-return system includes a multi-spout valve forming a diaphragm that opens during suction and closes when suction is stopped.

Advantageously, the third wheel can be self-steering according to the direction of movement of the robot, said wheel having at least two different orientations depending on whether the robot is moving forward or backward.

According to one aspect of the disclosure, a drive wheel located on the side opposite the motor is connected to the motor axis by a delayed clutch mechanism, delaying its rotation with respect to the other drive wheel, and thus causing an offset of the alignment of the robot at each change of direction of the movement of the robot between a forward movement and a backward movement.

According to one aspect, the axis of the axle is mounted pivoting back and forth according to the direction of rotation of the motor.

According to some aspects, the robotic vacuum cleaner can include a Hall effect sensor placed on the third wheel, an accelerometer type inertial sensor or a timer device, all configured to control the direction of rotation of the motor.

According to one aspect of the disclosure, the robotic vacuum cleaner further includes two lateral wheels on either side of the third wheel.

The fundamental concepts of the disclosure having been disclosed hereinabove in their most elementary form, other details and features will become more apparent upon reading the following description with reference to the appended drawings, giving, by way of non-limiting example, an aspect of a robotic vacuum cleaner for cleaning swimming pools, in accordance with the principles of the disclosure.

### BRIEF DESCRIPTION OF THE DRAWINGS

The figures are given purely by way of illustration for better understanding of the disclosure without limiting the scope thereof. The various elements may be shown schematically and are not necessarily to scale. In the set of figures, identical or equivalent elements bear the same numerical reference.

Thus, it is illustrated in:

FIG. 1: a perspective top view of a robotic vacuum cleaner according to an aspect of the disclosure;

FIG. 2: a perspective bottom view of the robotic vacuum cleaner showing the large-diameter impeller;

FIG. 3: a bottom view of the robotic vacuum cleaner;

FIG. 4: a rear view of the robotic vacuum cleaner;

FIG. 5: a side view of the robotic vacuum cleaner;

FIG. 6: a front view of the robotic vacuum cleaner;

FIG. 7: a cross-section along the plane A-A of FIG. 6;

FIG. 8: a top view of the robotic vacuum cleaner;

FIG. 9: a cross-section along the plane B-B of FIG. 8;

FIG. 10: a diagram of movement of the robotic vacuum cleaner in a swimming pool, with a delayed drive wheel inducing arc-shaped parts in the trajectory;

FIG. 11: a partial view of a multi-spout non-return valve.

### DETAILED DESCRIPTION

It should be noted that certain technical elements well known to those skilled in the art are recalled herein to avoid any insufficiency or ambiguity in the understanding of the present disclosure.

In the aspect described hereinafter, reference is made to a robotic pool cleaner, primarily intended to suck up debris deposited at the bottom of a pool. This example, which is not exhaustive, is given for a better understanding of the disclosure and does not exclude adapting the robot to other applications such as cleaning other types of hard-bottomed artificial pools.

Hereinafter in the description, the term “robot” means an autonomous robotic vacuum cleaner for cleaning swimming pools.

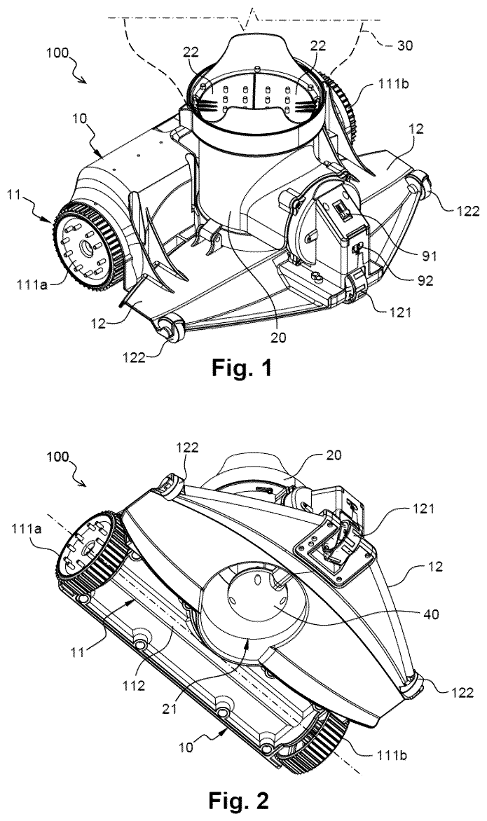

FIG. 1 shows a robotic pool cleaner 100 including a chassis 10 which forms the main supporting structure of the robot. A suction duct 20, through which debris is sucked up when the robotic vacuum cleaner 100 is used, is mounted on this chassis 10.

A filter bag 30, shown with a dotted line in FIG. 1, is provided to collect and hold the debris sucked up by the suction duct 20. The chassis 10 is also equipped with a drive axle 11, which supports two coaxial drive wheels: a first drive wheel 111a and a second drive wheel 111b. These drive wheels are actuated by a traction motor 50 (not seen in FIG. 1) to propel the robotic vacuum cleaner 100.

The chassis 10 has a flattened portion 12, the design of which can vary according to specific needs, such as reducing water resistance or accommodating other components. A third free wheel 121 is also present, allowing free rotation to improve the maneuverability of the robotic vacuum cleaner 100. Lateral wheels 122 are disposed on the sides of the chassis 10 to increase the stability of the robotic vacuum cleaner 100 during its movement.

The suction duct 20 further includes a non-return valve 22, located at the base of the filter bag 30 to prevent debris from returning to the water after it has been sucked up.

The non-return valve 22, according to the aspect of FIG. 1, includes two rigid parts hinged on a diametrical axis of the duct 20.

Alternatively, the non-return valve can include a single hinged rigid part.

FIG. 2 shows a perspective bottom view of the robotic vacuum cleaner 100, thus supplementing the view of FIG. 1. This view shows additional elements that are essential for the operation of the suction and mobility of the robot.

Under the robotic vacuum cleaner 100, there is a large-diameter impeller 40. The rotation of the impeller 40 makes it possible to generate a water current which facilitates the transport of debris to the suction duct 20, via a suction port 21.

The axis 112 is a mechanical component which connects the two drive wheels, 111a and 111b, in the drive axle 11. This axis is fundamental for power transmission from the traction motor to the wheels, thus ensuring coordinated and stable propulsion of the robotic vacuum cleaner 100 on the pool floor.

The suction port 21 is the orifice located at the lower part of the suction duct 20. It is through this opening that debris is captured from the bottom of the pool. The suction port 21 is designed to maximize suction effectiveness while minimizing the risk of blockage by large debris.

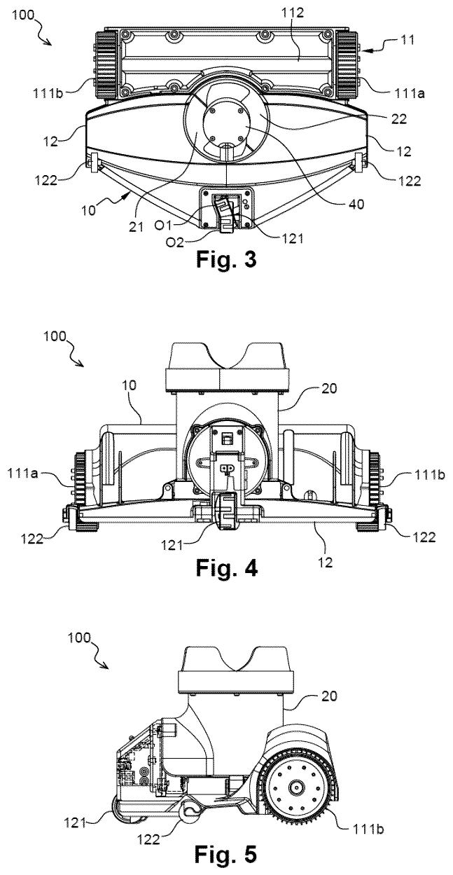

FIG. 3 shows a bottom view of the robotic vacuum cleaner 100, displaying the configuration of the third free wheel 121 and its orientation mechanism. This view is essential for understanding the operation of the third free wheel 121, which plays a key role in the maneuverability of the robotic vacuum cleaner 100.

The third free wheel 121 is designed to pivot and adopt at least two different orientations, O1 and O2, which can be seen in this figure. These orientations correspond respectively to the forward and backward movement modes of the robotic vacuum cleaner. When the robot moves forward (orientation O1), the free wheel 121 is oriented so as to facilitate this movement, whereas when it moves backward (orientation O2), the wheel adjusts to allow easy maneuvering in this direction.

The orientation mechanism of the third free wheel 121 is designed to automatically respond to the change of direction of the robotic vacuum cleaner. This feature improves the navigation of the robotic vacuum cleaner 100 by allowing it to get around obstacles and change direction with greater fluidity.

FIG. 3 also illustrates how the third free wheel 121 is mounted on the chassis 10 of the robotic vacuum cleaner 100. The wheel is positioned so that it can pivot freely about its axis, which is essential for both orientations O1 and O2.

FIGS. 4 and 5 respectively represent a rear view and a side view of the robotic vacuum cleaner 100, highlighting the lateral wheels 122 and their contribution to the stability of the apparatus. These lateral wheels 122 are disposed on either side of the third free wheel 121 and are designed to increase the lateral stability of the robotic vacuum cleaner during its movements.

The lateral wheels 122 play an essential role in preventing the robotic vacuum cleaner 100 from tipping over when it moves over uneven surfaces or when it changes direction. Their positioning and their sizing are developed to provide suitable support without compromising maneuverability or cleaning effectiveness.

In addition, the lateral wheels 122 can also contribute to the uniform distribution of the weight of the robotic vacuum cleaner 100, which is particularly advantageous during the suction of debris on slopes or edges of pools. This weight distribution ensures that the suction port 21 remains in close contact with the pool surface for maximum suction.

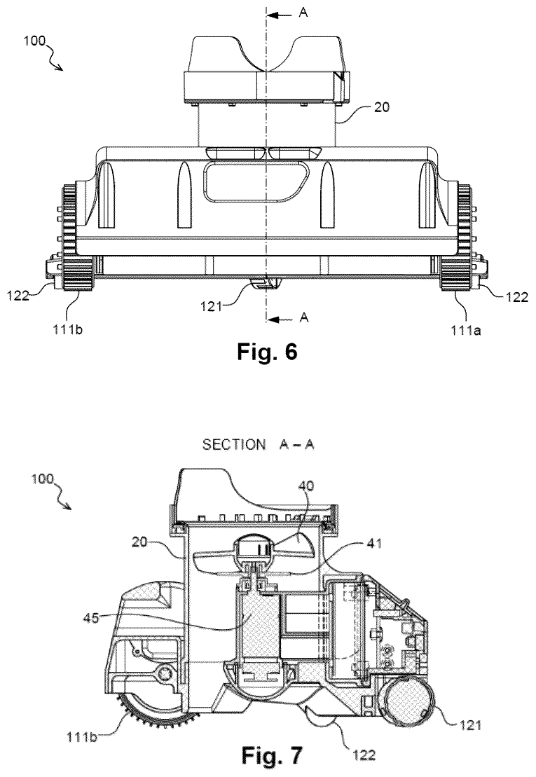

FIG. 7 illustrates a cross-section of the robotic vacuum cleaner 100 along the plane A-A of FIG. 6, showing internal elements not seen in the external views. This sectional view is particularly useful to understand the arrangement of the internal components and their operation.

At the heart of the suction system, we find the motor 45 of the impeller 40, which is responsible for impeller rotation. This motor is designed to supply the power required to generate a sufficient water current to suck up the debris from the bottom of the pool and convey it to the filter bag 30 through the suction duct 20.

Just below the impeller 40, the central baffle 41, a crucial part that plays a dual role, is located. Firstly, it prevents debris from accumulating directly under the impeller, which could hinder its operation and reduce suction effectiveness. Secondly, the central baffle 41 directs the water flow toward the inner walls of the suction duct 20, aiding the propulsion of debris toward the filter bag 30.

Such a baffle is described in patent EP3832053 held by the applicant.

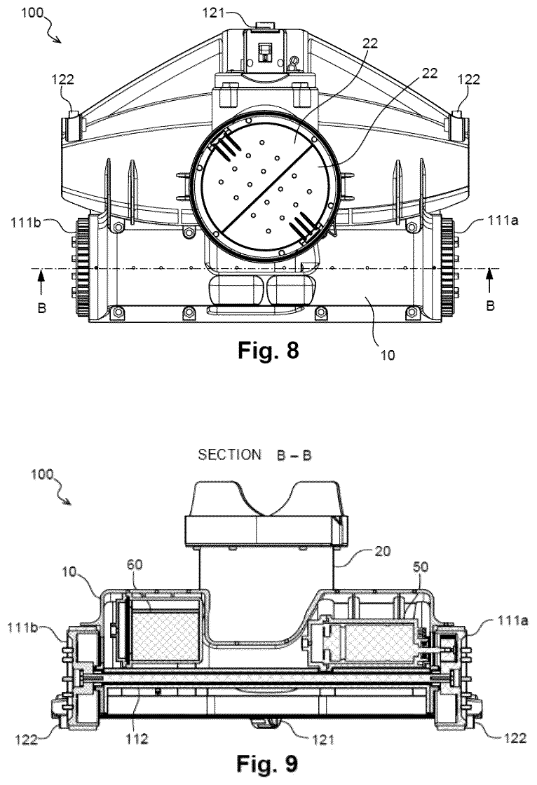

FIG. 9 shows a cross-section along the plane B-B of FIG. 8, providing a detailed view of the internal arrangement of the robotic vacuum cleaner 100, in particular of the propulsion system and the power supply.

The traction motor 50 is an essential element of the robotic vacuum cleaner 100, supplying the driving force necessary to move the apparatus. It is connected to the drive axle 11 and is responsible for driving the drive wheels 111a and 111b. The traction motor 50 is designed to invert its direction of rotation, which allows the robotic vacuum cleaner to change direction when it encounters an obstacle, such as a pool wall.

The direction of rotation of the motor 50, and hence the movement of the robot, can be controlled by various means. In some cases, a Hall sensor on the free wheel 121 or an accelerometer type sensor can be used. In other cases, a timer can be used. These control systems can offer the advantage of precise and adaptable movement control, enhancing the ability of the robot to clean different areas of the pool automatically and effectively.

The electric battery 60 is the power source of the robotic vacuum cleaner 100. It is placed inside the chassis 10 in a sealed compartment to balance the weight and maximize the stability of the robot during its operation. The electric battery 60 is designed to provide sufficient battery life to allow the robot to clean a pool without interruption.

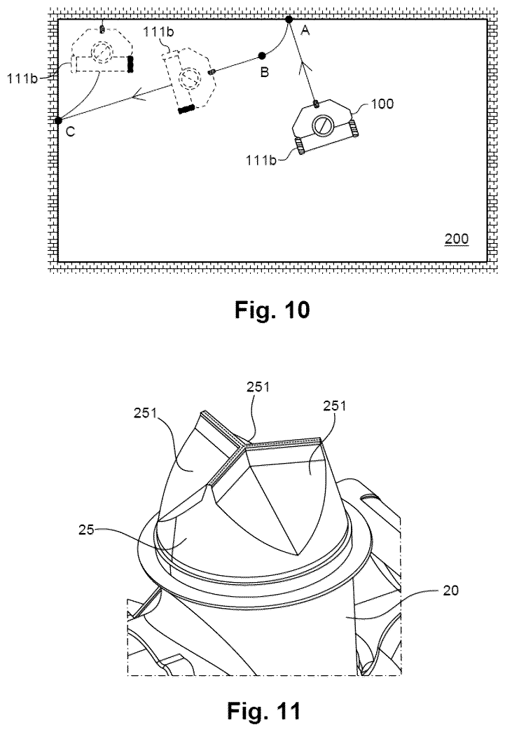

The axis 112 connects the two drive wheels 111a and 111b and plays a fundamental role in power transmission from the traction motor 50. A delayed clutch mechanism is integrated in this axis, in particular on the drive wheel 111b located on the side opposite the traction motor 50. This mechanism is designed to delay the rotation of the drive wheel 111b with respect to the drive wheel 111a. This delay in the activation of the drive wheel 111b causes a shift in the alignment of the robotic vacuum cleaner 100 during changes of direction between a forward and backward movement direction, thus inducing arc-shaped parts in the robot trajectory, as illustrated in FIG. 10.

This design with a delayed clutch mechanism on the axis 112 helps improve the maneuverability of the robotic vacuum cleaner 100 and increase cleaning effectiveness by allowing the robot to cover a greater surface area of the pool without leaving uncleaned areas.

FIG. 10 illustrates a diagram of movement of the robotic vacuum cleaner 100 at the bottom of a pool 200, showing the trajectory followed by the robot during its cleaning operation. The trajectory is characterized by a series of arcs AB, which are the direct result of the delayed activation of the delayed drive wheel 111b, extended by rectilinear portions BC.

The arcs AB are generated each time the robotic vacuum cleaner 100 changes direction, over a short period with respect to the rectilinear parts BC. When the robot moves forward and it is necessary to change direction, for example after encountering a pool wall, the delayed clutch mechanism integrated in the axis 112 delays the rotation of the drive wheel 111b with respect to the drive wheel 111a. This delay creates an offset in the alignment of the robot, which causes the robot to follow an arc-shaped trajectory AB instead of a tight curve or an inversion of direction in a straight line.

This feature of movement in arcs allows the robotic vacuum cleaner 100 to gradually shift its cleaning direction, thus ensuring better coverage of the bottom of the pool 200. Thanks to this navigation method, the robot is able to clean more effectively by avoiding passing in the same place several times and reducing uncleaned areas. The arc-shaped trajectory AB therefore contributes to a more even distribution of cleaning and a more effective use of the robot operating time.

In sum, FIG. 10 demonstrates the effectiveness of the delayed clutch mechanism on the axis 112 in improving maneuverability and cleaning coverage of the robotic vacuum cleaner 100, illustrating how the arcs AB allow the robot to modify its trajectory for complete and systematic coverage of the bottom of the pool 200.

FIG. 11 shows an aspect wherein the non-return valve is replaced by a multi-spout 251 valve 25, acting as a diaphragm.

Indeed, the diaphragm is composed of several flaps or spouts 251. These spouts 251 are designed to open and close synchronously to allow the debris-charged water sucked up to flow in a single direction through the suction duct 20.

When the robot is vacuuming, the pressure increases in the duct 20 located upstream of the valve 25. This additional pressure forces the spouts 251 of the diaphragm to open, allowing the debris sucked up to pass through the duct to end up in the filter bag.

After the “dirty” water has passed through the valve and the suction stops, the pressure decreases. This causes the spouts 251 of the diaphragm to close, preventing debris from flowing back into the suction duct.

What is claimed is:

1. A robotic pool cleaning vacuum, including a chassis, a suction duct topping the chassis and opening into a filter bag placed above, and an impeller placed inside said duct to suck up debris via a suction port and push it into the filter bag, the chassis comprising a motor axle towing the robot, said robot being characterized in that the axle (11) is single and includes two drive wheels driven by a single motor, and an axis connecting said drive wheels transversely to the movement of the robot, in that the motor is configured to invert its direction of rotation in contact with a wall, and in that said robot further includes a third free wheel and a non-return system placed between the suction duct and the filter bag to prevent the debris pushed into said bag from falling back into said duct.

2. The robotic vacuum cleaner according to claim 1, wherein the non-return system includes at least one hinged rigid flap.

3. The robotic vacuum cleaner according to claim 1, wherein the non-return system includes a valve with several spouts forming a diaphragm that opens during suction and closes when suction is stopped.

4. The robotic vacuum cleaner according to claim 1, wherein the third wheel is self-steering according to the direction of movement of the robot, said wheel having at least two different orientations depending on whether the robot is moving forward or backward.

5. The robotic vacuum cleaner according to claim 1, wherein a drive wheel located on the opposite side of the motor is connected to the axis of the motor by a delayed clutch mechanism, delaying its rotation with respect to the other drive wheel, and thus causing an offset of the alignment of the robot at each change of direction of the movement of the robot between a forward movement and a backward movement.

6. The robotic vacuum cleaner according to claim 1, wherein the axis of the axle is mounted pivoting back and forth according to the direction of rotation of the motor.

7. The robotic vacuum cleaner according to claim 1, including a Hall effect sensor placed on the third wheel and configured to control the direction of rotation of the motor.

8. The robotic vacuum cleaner according to claim 1, including an accelerometer type inertial sensor configured to control the direction of rotation of the motor.

9. The robotic vacuum cleaner according to claim 1, including a timer device configured to control the direction of rotation of the motor.

10. The robotic vacuum cleaner according to claim 1, further including two lateral wheels on either side of the third wheel.
